(19) United States
(12) Patent Application Publication
(10) Pub. No.: US 2012/0024263 A1
(43) Pub. Date: Feb. 2, 2012

(54) METHOD FOR ESTIMATING FUEL INJECTING PRESSURE

(75) Inventors: Massimiliano MELIS, Chieri (IT); Matteo ALLASIA, Fossano (IT); Vincenzo RAMPINO, Torino (IT); Paolo ZAMBONI, Torino (IT)

(73) Assignee: GM GLOBAL TECHNOLOGY OPERATIONS, INC., Detroit, MI (US)

(21) Appl. No.: 12/916,391

(22) Filed: Oct. 29, 2010

(30) Foreign Application Priority Data
Nov. 3, 2009 (GB) 0919307.9

(51) Int. Cl. F02M 69/46

(52) U.S. Cl. 123/456

(57) ABSTRACT

A method is provided for estimating fuel injecting pressure of an injector belonging to a fuel injection system of an internal combustion engine. The fuel injection system includes, but is not limited to a fuel rail and at least one injector that are fluidly connected with the fuel rail through a connecting conduit. The method includes, but is not limited to modelling the pressure fluctuation within the connecting conduit according to the equation P=B·e^{-At} cos(ωt), where A, B and ω are parameters, and t is a variable representing time, determining the dwell time between the injector opening and injector previous closing, and applying the determined dwell time to the equation in order to calculate the fuel injecting pressure.

### CROSS-REFERENCE TO RELATED APPLICATION

This application claims priority to British Patent Application No. 0919307.9, filed Nov. 3, 2009, which is incorporated herein by reference in its entirety.

### TECHNICAL FIELD

The technical field generally relates to a fuel injection system of an internal combustion engine, in particular of a Diesel engine, and more particularly relates to a method for estimating the fuel injecting pressure of an injector belonging to said fuel injection system.

### BACKGROUND

It is known that gasoline and diesel engines are provided with a fuel injection system. Such fuel injection system generally comprises a fuel rail and a plurality of electrically controlled injectors, which are fluidly connected with the rail through respective connecting conduits and are repeatedly opened and closed, in order to supply metered injections of fuel into the engine. During a single injection, an injector supply a fuel quantity which depends on the fuel injecting pressure at time of injector opening, and on the pulse width, that is the time between the injector opening and subsequent closing.

The fuel injecting pressure in generally measured by means of a pressure sensor which is set inside the rail. However, the pressure in the rail does not always correspond to the fuel injecting pressure, since the latter is influenced by a pressure wave which is generated by the previous fuel injection of the same injector, and which propagates along the connection conduit, producing therein a pressure fluctuation in the neighbourhood of the rail pressure.

Starting from the end of the previous injection, this pressure fluctuation progressively dampens, and stabilizes at the rail pressure value after a damping period depending on the rail pressure value itself, and on the fuel quantity which has been injected by the injector during the previous injection. Therefore, this pressure fluctuation can generally be disregarded when the dwell time between two subsequent injections is sufficiently long, such as for example when the injector is provided for performing one single injection per engine cycle.

On the contrary, the pressure fluctuation must be strictly taken into account when the dwell time between two subsequent injections is very short, such as for example when the injector is provided for performing a plurality of injections per engine cycle, according to a multi-injection pattern. Disregarding the pressure fluctuation in the latter case, it would mean to introduce an error in the determination of fuel injecting pressure, which reflects in a fuel injected quantity deviation with respect to the expected one, leading to a worse fuel combustion and to polluting emissions and noise increases.

In order to avoid such drawbacks, there have been considered many strategies, which take into account the pressure fluctuation effect by applying a proper correcting factor to the pressure value measured in the rail. Such correcting factor is generally determined by an engine controller (ECU), using an empirically determined data set or map, which correlates the correcting factor to the dwell time, the fuel quantity injected during the previous injection, and to a plurality of other important engine operating parameters, such as for example engine speed and engine load. The correcting factors stored in said data set or map are experimentally evaluated through a calibration activity. Such calibration activity generally provides to operate the injectors of a test fuel injection system under different values of the dwell time, previous injected fuel quantity, and each other engine operating parameters.

For each combination of said values, the calibration activity further provides to measure the fuel injecting pressure in the connecting conduits, and to compare such pressure measures to the pressure within the fuel rail, in order to evaluate the proper correction factors that must be stored in the data set or map. It follows that an important drawback of the current strategies is the very deep calibration activity, which generally requires long time and high cost to be completed.

In view of the foregoing, at least on object is to solve, or at least to positively reduce, the above mentioned drawbacks with a simple, rational and inexpensive solution. In addition, other objects, desirable features, and characteristics will become apparent from the subsequent summary and detailed description, and the appended claims, taken in conjunction with the accompanying drawings and this background.

### SUMMARY

A method is provided for estimating fuel injecting pressure of an injector belonging to a fuel injection system of an internal combustion engine, wherein said fuel injection system comprises a fuel rail and at least one injector, which is fluidly connected with the fuel rail through a connecting conduit.

The method comprises the step of modelling the pressure fluctuation within the connecting conduit according to the equation:

P=B·e^{-At} cos(ωt)

This equation is derived from the lamped parameter model of the system. A, B and ω are parameters, and t is a variable representing time, determining the dwell time between the injector opening and injector previous closing, and applying said determined dwell time to said equation, in order to calculate the fuel injecting pressure.

As a matter of fact, an estimation strategy is provided that is based on a lamped parameter model of the pressure within the connecting conduit.

The parameters A and B generally depend on the pressure within the fuel rail, on the fuel quantity which has been injected by the same injector during the previous injection, on fuel injection system aging factors and production spread. The parameter ω generally depends on the geometric layout of the fuel injection system. The evaluation of the parameters A, B and ω can require an experimental calibration activity, which nevertheless needs less effort than that needed by the current strategies. Moreover, once the parameters A, B and ω have been evaluated, the method according to the invention allows a more accurate estimation of the fuel injecting pressure, which reflects in polluting emissions and noise reductions. The experimentally evaluated parameters A and B can eventually be stored in respective data sets or maps, which correlates the values of the parameters A and B to the fuel rail pressure and previous fuel injected quantity.

According to an embodiment of the invention, the method further comprises the step of determining the pressure within the fuel rail, determining the fuel quantity which has been injected by the injector during the previous injection, and using said determined fuel rail pressure and previous fuel injected quantity for determining parameters A and B. The fuel rail pressure can be measured by means of a pressure sensor set inside the fuel rail, while previous fuel injected quantity can be determined from an empirically data set or map correlating said quantity to a plurality of engine operating parameters, such as for example engine speed and engine load. Knowing fuel rail pressure and previous fuel injected quantity, the parameters A and B can be determined from the empirically determined data sets or maps, which respectively correlates the evaluated parameters A and B to the fuel rail pressure and previous fuel injected quantity. Eventually, the determined parameters A and B can be subsequently corrected on the base of fuel injection system aging factor and/or production spread. According to an embodiment, the parameter ω is constant for the specific geometrical layout of the fuel injection system, and is empirically determined.

According to another embodiment, the dwell time 1 between injector opening and injector previous closing can be determined through the phases of determining the time interval between the injector opening and the injector previous opening, determining the pulse width of the previous injection which has been performed by the injector, using said determined time interval and said determined previous pulse width for calculating the dwell time between injector opening and injector previous closing.

The method can be involved in a wider method for operating a fuel injection system of an internal combustion engine, in order to avoid deviation in fuel injected quantity due to pressure fluctuation effects. As a matter of fact, such method for operating a fuel injection system comprises the step of determining the fuel quantity to be injected by an injector during a single injection, estimating the fuel injecting pressure as previously set forth in the embodiments of the invention, and using said determined fuel quantity and said estimated fuel injecting pressure for calculating the pulse width that must be applied to said injector.

The methods can be realized in the form of a computer program comprising a program-code to carry out all the steps of the methods of the invention and in the form of a computer program product comprising means for executing the computer program. The computer program product comprises, according to an embodiment, a microprocessor based control system for an internal combustion engine, for example the ECU of the engine, in which the program is stored so that the control apparatus operates in accordance with the method. In this case, when the control system executes the computer program all the steps of the method are carried out.

The method can be also realized in the form of an electromagnetic signal, said signal being modulated to carry a sequence of data bits which represent a computer program to carry out all steps of the method of the invention.

### BRIEF DESCRIPTION OF THE DRAWINGS

The present invention will hereinafter be described in conjunction with the following drawing figures, wherein like numerals denote like elements, and:

FIG. 1 is a schematic illustration of a fuel injection system of a Diesel engine; and

FIG. 2 is schematic illustration of a portion of an injection pattern that shows along a timeline two subsequent injections performed by a same injector belonging to the fuel injection system of FIG. 1.

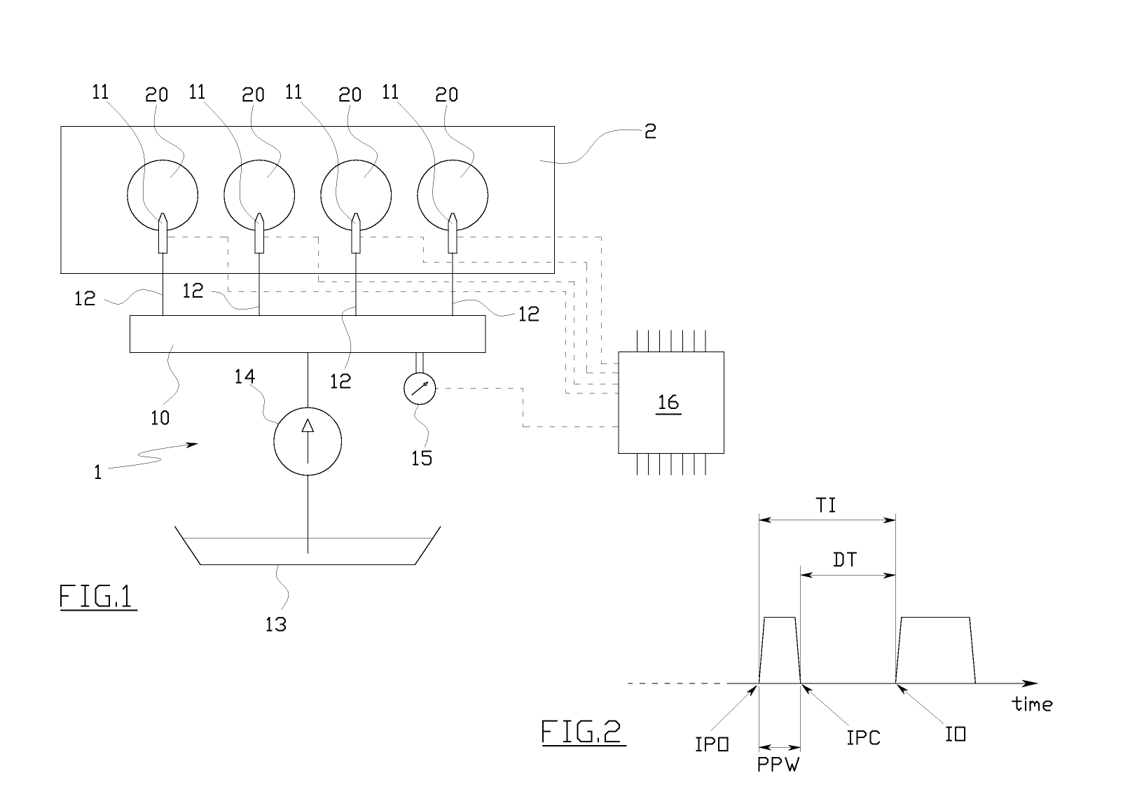

### DETAILED DESCRIPTION

The following detailed description is merely exemplary in nature and is not intended to limit application and uses. Furthermore, there is no intention to be bound by any theory presented in the preceding background or summary or the following detailed description. Moreover, while the invention is hereinafter described with reference to a fuel injection system 1 of a Diesel engine 2, it can be also applied to a fuel injection system of a spark-ignited internal combustion engine.

The fuel injection system 1 comprises a fuel rail 10 and a plurality of injectors 11, each of which is set inside a respective cylinder 20 of the Diesel engine 2, and is fluidly connect to the fuel rail 10 through a connecting conduit 12.

Each injector 11 generally comprises a needle and an electrical actuator, which moves the needle between a closing position, in which the injector 11 prevents the fuel contained in the rail 10 to exit, and an opening position, in which the injector 11 allows the fuel contained in the rail 10 to be supplied into the correspondent cylinder 20. The time between the each injector opening and subsequent injector closing is usually called pulse width, and defines a single fuel injection.

The fuel injection system 1 further comprises a fuel tank 13, a pump 14 for supplying fuel from the tank 13 into the fuel rail 10, conventional means (not shown) for regulating the pressure within the fuel rail 10, in order to maintain it within a predetermined range of values, and a pressure sensor 15 set inside the fuel rail 10 for measuring pressure therein. The fuel injection system 1 comprises also a microprocessor based controller 16 (ECU), which generates and applies electric signals to the actuator of the injectors 11, in order to repeatedly open and close each individual injector 11, so that it supplies fuel into the correspondent engine cylinder 20 through a plurality of subsequent injections during engine functioning. In particular, the controller 16 of the present embodiment is configured for commanding each injector 11 to perform a plurality of fuel injections per engine cycle, according to a multi-injection pattern which generally comprises at least a pre-injection, a main injection and an after injection.

The controller 16 is also configured for regulating the injection pattern and the individual injections of said pattern, on the base of a plurality of engine operating parameters, such as for example engine speed or engine load. For example, the controller 16 is able to regulate the fuel quantity which is injected by means of each individual injector 11 during each single injection.

As a matter of fact, the fuel quantity which is injected by one injector 11 during a single injection depends on the pulse width and on the fuel injecting pressure at the time of injector 11 opening, which is the pressure within the respective connecting conduit 12 when the injector 11 opens.

A method is provided for estimating said fuel injecting pressure, taking into account the pressure fluctuation within the connecting conduit 12 due to the previous injection performed by the same injector 11. The method is hereinafter disclosed with reference to a single injector 11, because it can be identically applied to each injector 11 of the fuel injection system 1.

The method provides to model the pressure fluctuation within the connecting conduit 12 according to the equation:

P=B·e^{-At} cos(ωt) (1)

Where t is a variable representing time; A and B are parameters depending mainly on the pressure (FRP) within the fuel rail 10, and on the fuel quantity (PFQ) that has been injected by the injector 11 during the previous injection; and ω is a parameter depending on the geometrical layout of the fuel injection system 1. The parameter ω is constant, so that it is empirically determined and memorized in the ECU 16. The parameters A and B are determined by the ECU 16 starting from the determination of the fuel rail pressure and previous fuel injected quantity.

The equation comes from the lamped parameter model of the system. A and B are determined by means of fitting of the measured pressure wave with the above mentioned equation varying the fuel rail pressure (FRP) and the fuel injected quantity. The two parameters are chosen keeping the error between the measured pressure and the computed one the lowest possible according to the least mean square approach.

The fuel rail pressure (FRP) is measured by the ECU 16 through the pressure sensor 15, while previous fuel injected quantity (PFQ) is determined by the ECU 16 from an empirically data set or map, which correlates previous fuel injected quantity (PFQ) to a plurality of engine operating parameters, such as for example engine speed and engine load.

The parameters A and B are finally determined by the ECU 16 from empirically determined data sets or maps, which respectively correlates parameters A and B to the fuel rail pressure (FRP) and previous fuel injected quantity (PFQ). Eventually, such empirically determined data sets or maps can respectively correlates parameters A and B also to a plurality of other engine operating parameters, such as for example engine speed and engine load. It has been found that parameters A and B depend also on aging factor and/or on production spread of the components of the fuel injection system 1.

Accordingly, the method provides for the ECU to eventually correct the determined parameters A and B on the base of such fuel injection system aging factor and/or production spread.

According to the invention, the method further comprises the step of determining the dwell time DT between the injector 11 opening and injector 11 previous closing, and applying said determined dwell time DT to the equation representing the pressure fluctuation, in order to calculate the fuel injecting pressure at the time of injector 11 opening.

With reference to FIG. 2, the dwell time DT can be determined by the ECU 16 with the phases of determining the time interval TI between the injector opening 10 and the injector previous opening IPO, determining the pulse width PPW of the previous injection which has been performed by the injector 11, subtracting said determined previous pulse width PPW from said determined time interval TI for obtaining the dwell time DT between injector opening 10 and injector previous closing IPC. The time interval TI and the previous pulse width PPW can be determined by the ECU 16 from empirically determined data sets or maps, which respectively correlates time interval TI and the previous pulse width PPW to a plurality of engine operating parameters, such as engine speed and engine load.

As stated above, the method of the invention can be used by the ECU 16 for regulating the fuel quantity which is injected by the injector 11 during a single injection, in order to avoid injected quantity deviation due to the pressure fluctuation effect within the connecting conduit 12. As a matter of fact, such regulation can be performed by the ECU 16 with the step of determining the fuel quantity to be injected by the injector 11, estimating the fuel injecting pressure according to the method previously disclosed, an using said determined fuel quantity and said estimated fuel injecting pressure for calculating the pulse width that musty be applied to the injector 11, for supplying the predetermined fuel quantity. Such fuel quantity can be determined by the ECU 16 from empirically determined data set or map correlating the fuel quantity to a plurality of engine operating parameters, such as engine speed and engine load.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for estimating a fuel injecting pressure of an injector belonging to a fuel injection system of an internal combustion engine, said fuel injection system comprising a fuel rail and at least one injector that is fluidly connected with the fuel rail through a connecting conduit, the method comprising the steps of:
modelling a pressure fluctuation within said connecting conduit according to an equation of P=B·e^{-At} cos(ωt), where A, B and ω are parameters, and t is a variable representing time;
determining a dwell time between an opening of the injector and a previous closing of the injector; and
applying said dwell time to said equation using a controller in order to calculate the fuel injecting pressure.

2. The method according to claim 1, further comprising the steps of:
determining a fuel rail pressure within the fuel rail;
determining a fuel quantity that has been injected by the injector during a previous injection; and
using said fuel rail pressure and the fuel quantity for determining A and B.

3. The method according to claim 2, wherein the fuel rail pressure is measured with a pressure sensor set inside the fuel rail.

4. The method according to claim 2, wherein the fuel quantity is determined from empirically determined data correlating said fuel quantity to a plurality of engine operating parameters.

5. The method according to claim 2, wherein A is determined from empirically determined data correlating A to at least the fuel rail pressure and the fuel quantity.

6. The method according to claim 2, further comprising the step of correcting A on a basis of a fuel injection system aging factor.

7. The method according to claim 2, further comprising the step of correcting A on a basis of a production spread.

8. The method according to claim 2, wherein B is determined from empirically determined data correlating B to at least the fuel rail pressure and the fuel quantity.

9. The method according to claim 2, further comprising the step of correcting B on a basis of a fuel injection system aging factor.

10. The method according to claim 2, further comprising the step of correcting B on a basis of a components production spread.

11. The method according to claim 2, that the step of determining the dwell time between the opening and the previous closing of the injector, comprises the steps of:
determining a time interval between the opening and the previous closing;
determining a pulse width of the previous injection which has been performed by the injector;
using said time interval and said pulse width of the previous injection for calculating the dwell time between the opening and the previous closing.

12. A fuel injection system of an internal combustion engine, comprising:
a fuel rail;
a connecting conduit;
an injector fluidly connected with the fuel rail through the connecting conduit; and
a controller adapted to:
determine a fuel quantity to be injected by said injector during a single injection;
estimate a fuel injecting pressure, the estimate comprising:
modelling a pressure fluctuation within said connecting conduit according to an equation of P=B·e^{-At} cos(ωt), where A, B and ω are parameters, and t is a variable representing time;
determining a dwell time between an opening of the injector and a previous closing of the injector; and
applying said dwell time to said equation in order to calculate the fuel injecting pressure; and
using said fuel quantity and said fuel injecting pressure for calculating a pulse width that must be applied to said injector.

13. The fuel injection system according to claim 12, the controller further adapted to:
determine a fuel rail pressure within the fuel rail;
determine the fuel quantity that has been injected by the injector during a previous injection; and
use said fuel rail pressure and the fuel quantity for determining A and B.

14. The fuel injection system according to claim 13, further comprising a pressure sensor adapted to measure the fuel rail pressure that is set inside the fuel rail.

15. The fuel injection system according to claim 13, wherein the fuel quantity is determined from empirically determined data correlating said fuel quantity to a plurality of engine operating parameters.

16. The fuel injection system according to claim 13, wherein A is determined form empirically determined data correlating A to at least the fuel rail pressure and the fuel quantity.

17. A computer readable medium embodying a computer program product, said computer program product comprising:
a program for estimating a fuel injecting pressure of an injector belonging to a fuel injection system of an internal combustion engine, said fuel injection system comprising a fuel rail and at least one injector that is fluidly connected with the fuel rail through a connecting conduit, the program configured to:
model a pressure fluctuation within said connecting conduit according to an equation of P=B·e^{-At} cos(ωt), where A, B and ω are parameters, and t is a variable representing time;
determine a dwell time between an opening of the injector and a previous closing of the injector; and
apply said dwell time to said equation using a controller in order to calculate the fuel injecting pressure.

18. The computer readable medium according to claim 17, the program further configured to correct A on a basis of a fuel injection system aging factor.

19. The computer readable medium according to claim 17, the program further configured to correct A on a basis of a production spread.

20. The computer readable medium according to claim 17, wherein B is determined from empirically determined data correlating B to at least a fuel rail pressure and a fuel quantity.
